(19) United States
(12) Patent Application Publication
(10) Pub. No.: US 2025/0092241 A1
(43) Pub. Date: Mar. 20, 2025

(54) POLYETHERALKANOL AMINE DISPERSANTS FOR NANOTUBE MATERIALS

(71) Applicant: Nanocomp Technologies Inc., The Woodlands, TX (US)

(72) Inventors: Mark Schauer, Merrick, NH (US); Matthew T. Meredith, The Woodlands, TX (US); Hui Zhou, The Woodlands, TX (US)

(21) Appl. No.: 18/727,557

(22) PCT Filed: Jan. 13, 2023
(86) PCT No.: PCT/US2023/010755

§ 371 Date: Jul. 9, 2024

Related U.S. Application Data
(60) Provisional application No. 63/299,163, filed on Jan. 13, 2022.

(51) Int. Cl. C08L 27/16; C08G 59/28; C08K 3/04; H01M 4/62; H01M 10/0525; H01M 10/054; H01M 12/08

(52) U.S. Cl. CPC C08L 27/16; C08G 59/28; C08K 3/041; H01M 4/62; H01M 4/625; H01M 10/0525; H01M 10/054; H01M 12/08; C08G 2650/50; C08K 2201/003; C08K 2201/004; C08K 2201/006; C08K 2201/016; C08L 2201/50; C08L 2203/20

(57) ABSTRACT

The present disclosure provides a nanotube dispersion that includes a dispersion medium, a polyetheralkanol amine dispersant and carbon nanotube material. The nanotube dispersion may be used in various applications, such as in the production of electrodes for secondary batteries.

### CROSS-REFERENCE TO RELATED APPLICATIONS

This application claims priority to U.S. Pat. App. Ser. No. 63/299,163 filed Jan. 13, 2022. The noted application is incorporated herein by reference.

### STATEMENT REGARDING FEDERALLY SPONSORED RESEARCH OR DEVELOPMENT

Not applicable.

### FIELD

The present disclosure is generally directed to a nanotube dispersion containing a polyetheralkanol amine dispersant. In addition, the present disclosure is directed to an electrode for a secondary battery including a current collector and a layer of the nanotube dispersion and an electrode active material disposed on the current collector, and to a secondary battery containing such an electrode.

### BACKGROUND

Carbon nanotubes (hereinafter, also referred to as “CNTs”) have a cylindrical structure in which flat sheets of graphite (graphene sheets) are rolled in around themselves. Due to their nanostructure specificity, carbon nanotubes exhibit a variety of properties. In particular, carbon nanotubes are superior to copper in terms of their current density resistance, which is at least 1000 times higher than that of copper, their thermal conductivity, which is about 10 times higher than that of copper, and their tensile strength, which is about 20 times higher than that of steel. However, despite these useful properties, the use of carbon nanotubes in various applications is limited due to their low solubility and low dispersibility (i.e., carbon nanotubes undergo strong Van der Waals attraction therebetween causing agglomeration instead of a uniform dispersion).

Historically, polymers such as poly(styrene sulfonate) (PSS), poly(phenylacetylene) (PAA), poly(meta-phenylenevinylene) (PmPV), polypyrrole (PPy), poly(p-phenylene benzobisoxazole) (PBO) and natural polymers have been used to wrap or coat carbon nanotubes to render them soluble in water or organic solvents. In addition, carbon nanotubes have been chemically modified by oxidation and fluorination or ultrasonically treated or mixed using a high-shear mixer to enhance their interaction with solvents and thus reduce their aggregation behavior. However, current dispersion technologies are not only expensive but can also degrade carbon nanotube properties leading to a reduction in aspect ratio, the introduction of defects and the requirement of higher carbon nanotube loadings in order to achieve a desired performance.

Thus, a need exists to provide new dispersion technologies which can effectively disperse carbon nanotubes in aqueous solutions or organic solutions without affecting their electrical and mechanical properties to allow the dispersions to be subsequently used in connection with various applications, such as in the production of electrodes for secondary batteries.

### SUMMARY

The present disclosure is generally directed to a nanotube dispersion containing a dispersion medium, a polyetheralkanol amine dispersant and a carbon nanotube material dispersed in the dispersion medium. In one embodiment, the carbon nanotube material includes entangled carbon nanotube bundles characterized as having one or more of the following characteristics: (i) a diameter of between about 1-100 nm, (ii) a length of between about 0.1-10 mm, (iii) a density of between about 0.7-1.9 g/cm³, (iv) an aspect ratio of at least about 100,000, (v) a strain to failure of between about 1.8-7%, and (vi) a surface area from about 100-300 m²/g.

The present disclosure also provides a slurry for a secondary battery electrode containing an electrode active material and the nanotube dispersion set forth above.

The present disclosure also provides an electrode for a secondary battery which includes a current collector and a layer formed on the current collector, where the layer is formed from the slurry for a secondary battery electrode set forth above.

Finally, the present disclosure provides a secondary battery including a positive electrode, a negative electrode, an electrolyte solution, and a porous separator where the electrode for a secondary battery set forth above is used as at least one of the positive electrode and negative electrode.

### BRIEF DESCRIPTION OF THE DRAWINGS

FIG. 1 is a diagram illustrating a system for direct collection of well-entangled networks of carbon nanotube material in accordance with various embodiments.

FIG. 2 is a graph illustrating the bulk resistivities for cathodes produced from aqueous nanotube dispersions.

### DETAILED DESCRIPTION

The present disclosure is generally directed to a nanotube dispersion containing a dispersion medium, a polyetheralkanol amine dispersant and a nanotube material, for example, a carbon nanotube material, dispersed in the dispersion medium. It has surprisingly been found that certain polyetheralkanol amines according to the present disclosure may be more effective in dispersing carbon nanotube material in a dispersion medium containing water than state of the art dispersion technologies. Furthermore, because of this enhanced dispersibility, organic solvents, such as 1-Methyl-2-pyrrolidinone (a known toxicant), generally used in connection with nanotube dispersions for the production of an electrode for a lithium-ion battery, may be replaced by a substantial fraction of water. It was also found that when a layer of the aqueous nanotube dispersions containing the polyetheralkanol amine dispersants was formed on a current collector, the nanotubes better adhered to the current collector, resulting in an electrode having a lower bulk resistivity and enhanced capacity. This was surprising and unexpected since electrodes produced from state of the aqueous nanotube dispersions absent the polyetheralkanol amine dispersants are known to be poorly adhered to the current collector and to produce an electrode having poor electrical conductivity.

The following terms shall have the following meanings:

The term “comprising” and derivatives thereof are not intended to exclude the presence of any additional component, step or procedure, whether or not the same is disclosed herein. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e., to at least one) of the grammatical object of the article.

The phrases “in one embodiment”, “according to one embodiment” and the like generally mean the particular feature, structure, or characteristic following the phrase is included in at least one aspect of the present disclosure and may be included in more than one aspect of the present disclosure. Importantly, such phases do not necessarily refer to the same aspect.

If the specification states a component or feature “may”, “can”, “could”, or “might” be included or have a characteristic, that particular component or feature is not required to be included or have the characteristic.

As used herein, the term “substantially free” refers to a composition or blend in which a particular compound or moiety is present in an amount that has no material effect on the composition or blend. In some embodiments, “substantially free” may refer to a composition or blend in which the particular compound or moiety is present in the composition or blend in an amount of less than 2% by weight, or less than 1% by weight, or less than 0.5% by weight, or less than 0.1% by weight, or less than 0.05% by weight, or even less than 0.01% by weight, based on the total weight of the composition or blend, or that no amount of that particular compound or moiety is present in the respective composition or blend.

The term “substantial fraction” refers to a percentage equal to or more than 50%, 51%, 55%, 60%, 65%, 70%, 75%, 80%, 85%, 90%, 95%, 99% or 100%, or in a range between any of the two percentage values.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The term “hydrocarbyl” refers to univalent substituents containing only hydrogen and carbon atoms and may be aliphatic, aromatic, acyclic or cyclic groups and/or linear or branched. Examples include alkyl-, cycloalkyl-, alkenyl-, alkadienyl-, cycloalkenyl-, cycloalkadienyl-, aryl-, and alkynyl-groups.

It is envisaged that the term “dispersed” may include where the carbon nanotube material is present substantially throughout the dispersion medium without being present in a substantially higher concentration in any part of the dispersion medium. Additionally, the term “dispersed” may also include the carbon nanotube material being present in localized areas of the dispersion medium.

According to one embodiment, the nanotube dispersion includes a polyetheralkanol amine dispersant. The polyetheralkanol amine dispersants useful in the present disclosure are described in US 2008/0119613, the contents of which are incorporated herein by reference.

Thus, in one embodiment, the polyetheralkanol amine dispersant is a mixture comprising a compound having a structure of formula (1) and a compound having a structure of formula (2)

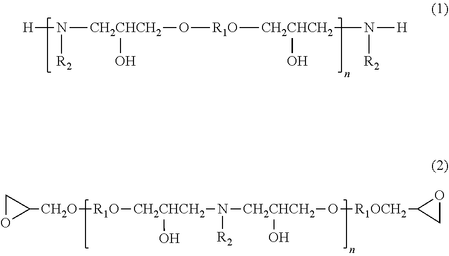

wherein each R₁ is a C₁-C₁₀₀ hydrocarbyl group; each R₂ is an alkoxylated hydrocarbyl group having a structure

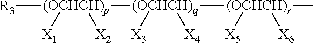

where R₃ is a C₁-C₂₄ hydrocarbyl group, X₁, X₂, X₃, X₄, X₅, and X₆ in each occurrence are independently selected from the group consisting of hydrogen, methyl and ethyl, subject to the proviso that at least one of the two X groups that are attached to the same alkoxy unit are hydrogen, p, q, and r may each independently be any integer from zero to about 100, subject to the proviso that at least one of p, q, and r is not zero; and each n is any integer from 1 to about 50. In one embodiment, each n is any integer from 1 to about 10 when the hydrocarbyl group is aromatic. In another embodiment, each n is any integer from 1 to about 50 when the hydrocarbyl group is aliphatic.

The polyetheralkanol amine dispersant may be obtained by reacting a monofunctional amine-terminated polyether with a glycidyl ether of a polyol. The monofunctional amine-terminated polyether reactant and the glycidyl ether of a polyol reactant may each comprise mixtures of monofunctional amine-terminated polyethers and glycidyl ethers of polyols, respectively. In some embodiments, the monofunctional amine-terminated polyether is present in an amount sufficient to ensure that the total number of reactive hydrogen atoms on the nitrogen atom of the amine is at least stoichiometrically equal to the amount of epoxide groups present in the glycidyl ethers of a polyol. The reaction may be generally represented by:

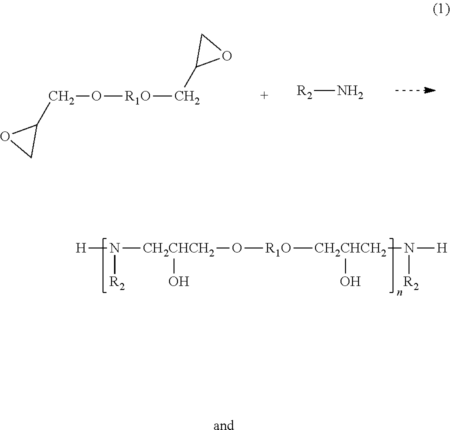

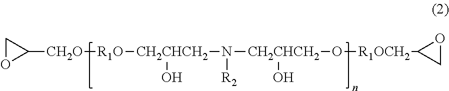

where each R₁ in the above reaction may be any C₁-C₁₀₀ hydrocarbyl group; each n is any integer from 1 to about 50; each R₂ may be any hydrocarbyl group which includes as a part of its molecular structure a portion containing at least two alkoxy groups linked to one another, i.e., the group R₂ may be a hydrocarbyl group having a structure

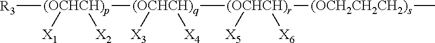

where R₃ is a C₁-C₂₄ hydrocarbyl group; X₁, X₂, X₃, X₄, X₅, and X₆ in each occurrence are independently selected from the group consisting of hydrogen, methyl and ethyl, subject to the proviso that at least one of the two X groups that are attached to the same alkoxy unit are hydrogen, p, q, and r may each independently be any integer from zero to about 100, subject to the proviso that at least one of p, q, and r is not zero, and s is 0 or 1.

Thus, the monofunctional amine-terminated polyether may be represented by a compound having a structure

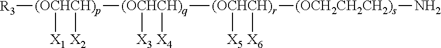

where R₃, X₁, X₂, X₃, X₄, X₅, X₆, p, q, r and s are defined as above. Accordingly, the above structures include without limitation, compounds having both random and block polymers and co-polymers of any one or more of the following, either alone or mixed with one another in any proportion: ethylene oxide (“EO”), propylene oxide (“PO”), and butylene oxide (“BO”). According to one embodiment, the monofunctional amine-terminated polyether has a molecular weight between about 100 and about 12,000 Daltons, or between about 250 to about 3500 Daltons, or between about 1000 to about 3000 Daltons, or between about 1500 to about 2000 Daltons. In embodiments where mixtures of monofunctional amine-terminated polyethers are employed to produce the polyetheralkanol amine provided herein, the molecular weight will be an average molecular weight of all amines present.

Particular examples of monofunctional amine-terminated polyethers that may be used include, but are not limited to, JEFFAMINE® M-1000 amine, a 1000 molecular weight polyethylene glycol based methyl capped amine, JEFFAMINE® M-600 amine, a 600 molecular weight polypropylene glycol based methyl capped amine, JEFFAMINE® M-2070 amine, a 2070 molecular weight polyethylene glycol based methyl capped amine, JEFFAMINE® M-2005 amine, a 2005 molecular weight polypropylene glycol based methyl capped amine, SURFONAMINE® B-60 amine, a 600 molecular weight methyl capped amine having a PO/EO ratio of 9/1, SURFONAMINE® E L-100 amine, a 1000 molecular weight methyl capped amine having a PO/EO ratio of 3/19, SURFONAMINE® B-200 amine, a 2000 molecular weight methyl capped amine having a PO/EO ratio of 29/6, SURFONAMINE® L-207 amine, a 2000 molecular weight methyl capped amine having a PO/EO ratio of 10/31, SURFONAMINE® L-300 amine, a 3000 molecular weight methyl capped amine having a PO/EO ratio of 8/58, SURFONAMINE® B-30 amine, a 325 molecular weight C₁₃ alkyl capped amine having two to three PO groups, and SURFONAMINE® B-100 amine, a 1004 molecular weight nonyl phenyl capped amine having 13.5 parts PO.

In one particular embodiment, the monofunctional amine-terminated polyether is a compound having a structure

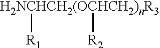

where R₁ and R₂ are each independently selected from the group consisting of hydrogen and a C₁-C₄ hydrocarbyl group, R₃ is selected from the group consisting of hydrogen, methyl, methoxy, ethoxy, and hydroxy; and n is any integer in the range of between about 5 and 100.

The glycidyl ether of a polyol can be obtained from the reaction of a compound having at least two free alcoholic hydroxyl groups and/or phenolic hydroxyl groups with epichlorohydrin or β-methylepichlorohydrin under alkaline conditions or in the presence of an acidic catalyst with subsequent treatment of an alkali.

The glycidyl ethers of this type can be based on, for example, acyclic alcohols, for example from ethylene glycol, diethylene glycol or higher poly(oxyethylene) glycols, propane-1,2-diol or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, pentaerythritol or sorbitol. Further glycidyl ethers of this type can be based on cycloaliphatic alcohols, such as 1,4-cyclohexanedimethanol, bis(4-hydroxycyclohexyl)methane or 2,2-bis(4-hydroxycyclohexyl)propane, or from alcohols which contain aromatic groups and/or further functional groups, such as N,N-bis(2-hydroxyethyl)aniline or p,p′-bis(2-hydroxyethylamino)-diphenylmethane.

The glycidyl ethers can also be based on mononuclear phenols, such as, for example, p-tert-butylphenol, resorcinol or hydroquinone, or on polynuclear phenols, such as, for example, bis(4-hydroxyphenyl)methane, 4,4′-dihydroxybiphenyl, bis(4-hydroxyphenyl) sulphone, 1,1,2,2-tetrakis(4-hydroxyphenyl)ethane, 2,2-bis(4-hydroxyphenyl)propane or 2,2-bis(3,5-dibromo-4-hydroxyphenyl)propane.

Further suitable hydroxy compounds for the preparation of glycidyl ethers are novolaks obtainable by condensation of aldehydes, such as formaldehyde, acetaldehyde, chloral or furfuraldehyde, with phenols or bisphenols which are unsubstituted or substituted by chlorine atoms or C₁-C₉ alkyl groups, such as, for example, phenol, 4-chlorophenol, 2-methylphenol or 4-tert-butylphenol.

In one embodiment, particularly important representatives of glycidyl ethers of polyols are based on monocyclic phenols, for example, on resorcinol or hydroquinone, on polycyclic phenols, for example, on bis(4-hydroxyphenyl)methane (Bisphenol F), 2,2-bis(4-hydroxyphenyl)propane (Bisphenol A), bis(4-hydroxyphenyl)sulfone (Bisphenol S), alkoxylated Bisphenol A, F or S, triol extended Bisphenol A, F or S, brominated Bisphenol A, F or S, hydrogenated Bisphenol A, F or S, glycidyl ethers of phenols and phenols with pendant groups or chains, on condensation products, obtained under acidic conditions, of phenols or cresols with formaldehyde, such as phenol novolaks and cresol novolaks, or on siloxane diglycidyls.

The monofunctional amine-terminated polyether and glycidyl ether of a polyol reactants are present in such amounts that the amine group of the polyether is able to be consumed by reacting with essentially all of the epoxide functionality of the glycidyl ether. Thus, during the reaction, the amount of monofunctional amine-terminated polyether is stoichiometrically equal to or greater than the amount of epoxide in the glycidyl ether of a polyol. The resulting product has little if any unreacted epoxide functionality left after the reaction.

Depending on the starting amounts used, it is possible to form either a secondary or tertiary amine in the final product. It is therefore possible to form products which contain repeating units where a monofunctional amine-terminated polyether has reacted with two epoxide groups to form a tertiary amine. This product can be depicted by the following representative formula

RNHCH₂CH(OH)CH₂—[O-A-O—CH₂CH(OH)CH₂NRCH₂CH(OH)CH₂—O-]ₓ-A-O—CH₂CH(OH)CH₂—NHR

where R represents the capped polyether portion of the monofunctional amine-terminated polyether, A represents the hydrocarbyl radical of the glycidyl ether of the polyol, such as the hydrocarbon portion of bisphenol A; and x can vary from 0 (if no tertiary amine is present) to about 100.

In one embodiment, the nanotube dispersion includes at least about 0.01% by weight, based on the total weight of the nanotube dispersion, of the polyetheralkanol amine dispersant. In still other embodiments, the nanotube dispersion includes at least about 0.05% by weight, or at least about 0.1% by weight, or at least about 0.25% by weight, or at least about 0.5% by weight, or at least about 0.75% by weight, or at least about 1% by weight, based on the total weight of the nanotube dispersion, of the polyetheralkanol amine dispersant.

In another embodiment, the nanotube dispersion includes less than about 20% by weight, based on the total weight of the nanotube dispersion, of the polyetheralkanol amine dispersant. In still other embodiments, the nanotube dispersion includes less than about 15% by weight, or at less than about 10% by weight, or at less than about 7.5% by weight, or at less than about 5% by weight, or at less than about 4% by weight, or at less than about 3% by weight, based on the total weight of the nanotube dispersion, of the polyetheralkanol amine dispersant.

In yet another embodiment, the nanotube dispersion includes about 0.01% by weight to about 15% by weight, based on the total weight of the nanotube dispersion, of the polyetheralkanol amine dispersant. In yet another embodiment, the nanotube dispersion includes about 0.05% by weight to about 7.5% by weight, or about 0.1% by weight to about 5% by weight, or about 0.25% by weight to about 2.5% by weight, or about 0.5% by weight to about 1.5% by weight, based on the total weight of the nanotube dispersion, of the polyetheralkanol amine dispersant.

The nanotube dispersion further includes a dispersion medium. The dispersion medium may be aqueous or organic. In one embodiment the dispersion medium includes water, chloroform, chlorobenzene, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromethane, diethylene glycol, diethylene glycol ether, diethyl ether, diglyme, dimethoxymethane, dihydrolevoglucosenone (Cyrene) N,N-dimethylformamide, ethanol, ethylamine, ethyl benzene, ethylene glycol ether, ethylene glycol, ethylene glycol acetate, propylene glycol, propylene glycol acetate, ethylene oxide, formaldehyde, formic acid, glycerol, heptane, hexane, iodobenzene, 2-methyloxolane, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, terpineol, texanol, carbitol, carbitol acetate, butyl carbitol acetate, dibasic ester, propylene carbonate, pyridine, pyrrole, pyrrolidine, quinoline, 1.1.2.2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, 3-methyl-2-oxazolidinone, N,N′-dimethylethyleneurea, m-xylene, o-xylene, p-xylene, 1,2-dichlorobenzene, 1,3-dichlorobenzene, 1,4-dichlorobenzene, 1,2-dichloroethane, N-methyl-2-pyrrolidone, methylethyl ketone, dioxane, dimethyl sulfoxide or any mixture thereof. In one embodiment, the dispersion medium is substantially free of N-methyl-2-pyrrolidone. In another embodiment, the dispersion medium comprises at least one of 3-methyl-2-oxazolidinone and N,N′-dimethylethyleneurea.

In another embodiment, the dispersion medium is an aqueous dispersion medium and includes a substantial fraction of water thereby imparting at least some of water's polarity and solubility characteristics to the medium. Suitably, the aqueous dispersion medium contains at least 50% by weight, at least 60% by weight, at least 75% by weight, at least 90% by weight, at least 95% by weight, at least 98% by weight, or at least 99% by weight (e.g., essentially 100% by weight in some embodiments) water, based on the total weight of the aqueous dispersion medium.

The dispersion also includes a nanotube material dispersed in the dispersion medium.

According to one embodiment, the nanotube material includes carbon nanotubes having the particular characteristics: (i) a diameter of between about 1-100 nm, or between about 5 to 100 nm, or between about 12-90 nm, or between about 15-80 nm, or between about 17-60 nm, or between about 20-50 nm, or between about 25-30 nm (ii) a length of between about 0.01-10 mm, or between about 0.1-10 mm, or between about 0.2-9 mm, or between about 0.3-8 mm, or between about 0.44-7 mm, or between about 0.5 mm to 6 mm, or between about 1 to 6 mm, or between about 5-6 mm or from 1-10 mm, or greater than 1 mm (iii) a density of between about 0.3-1.9 g/cm³, or between about 0.35-1.8 g/cm³, or between about 0.5-1.7 g/cm³, or between about 0.1-1 g/cm³, or between about 0.3-1.1 g/cm³, (iv) an aspect ratio of at least about 10,000 or at least about 100,000, or at least about 250,000, or at least about 350,000, or at least about 500,000, or at least about 600,000 (v) a strain to failure of between about 1.8-7%, or between about 2-6.5% or between about 3-5%, (vi) and a surface area from about 100-300 m²/g, or from about 125-275 m²/g, or from about 150-250 m²/g or from about 175-225 m²/g. In further embodiments, in addition to the characteristics above, the carbon nanotubes may also be characterized as having a tensile strength of between about 0.2-3.2 GPa, or between about 0.3-3 GPa, or between about 0.3-2.8 GPa and/or a specific strength of between about 1800-2900 kN·M/kg, or between about 2000-2700 kN·M/kg or between about 2200-2600 kN·M/kg.

In one embodiment, the carbon nanotubes are at least partially entangled with each other.

Presently, there exist multiple processes and variations thereof for growing nanotubes and forming yarns, sheets or cable structures made from these nanotubes to act as a source carbon nanotube material for the nanotube dispersion. These processes include: (1) Chemical Vapor Deposition (CVD), a common process that can occur at or near ambient pressure or at high pressure, and at temperatures above about 400° C., (2) Arc Discharge, a high temperature process that can give rise to tubes having a high degree of perfection, and (3) Laser ablation.

In some embodiments, a CVD process or similar gas phase pyrolysis procedure known in the industry can be used to generate the appropriate nanotube material. Growth temperatures for a CVD process can be comparatively low ranging, for instance, from about 400° C. to about 1350° C. Carbon nanotubes, both single wall carbon nanotubes (SWNT) or multiwall carbon nanotubes (MWNT), may be grown, in some embodiments, by exposing nanoscaled catalyst particles in the presence of reagent carbon-containing gases (i.e., a gaseous carbon source). In particular, the nanoscaled catalyst particles may be introduced into the reagent carbon-containing gases, either by the addition of existing particles or by in situ synthesis of the particles from a metal-organic precursor, or even non-metallic catalysts. Although both SWNT and MWNT may be grown, in certain instances, SWNT may be selected due to their relatively higher growth rate and tendency to form rope-like structures which may offer advantages in handling, thermal conductivity, electronic properties and strength.

The carbon nanotubes utilized in this disclosure may be described as bare, pristine, unpurified or purified and may or may not have solubility in the given organic or aqueous dispersion medium prior to addition of the polyetheralkanol amine dispersant. The terms “bare” and/or “pristine” and/or “unpurified” describe carbon nanotubes that have had little or no treatment since their chemical synthesis. Carbon nanotubes of these types are primarily, but not limited to, materials that are available directly from the synthesis process. The term “purified” carbon nanotubes are primarily defined as carbon nanotubes that have been treated either chemically and/or thermally and/or physically to impart improved properties to the carbon nanotubes. Examples of such treatments include, but are not limited to, thermal and acid treatment to remove catalyst or amorphous carbon and thermally annealing to remove catalyst and/or reduce the number of carbon defect sites. Additionally, carbon nanotubes may be media milled to break down carbon nanotube aggregates to assist in carbon nanotube dispersing and processing. Various methods and approaches to purify carbon nanotubes are present in the literature and the materials prepared by any such techniques can be utilized in this disclosure.

It should be noted that although reference is made throughout the application to nanotubes synthesized from carbon, other compound(s), such as boron nitride, MoS2, or a combination thereof may be used in the synthesis of nanotubes in connection with the present disclosure. Furthermore, other methods, such as plasma CVD or the like can also be used to fabricate the nanotubes of the present disclosure.

In general, the carbon nanotube material can be any nanotube material, such as a carbon nanotube sheet, carbon nanotube strip, carbon nanotube tape, bulk-collected carbon nanotubes, carbon nanotube yarn, any other suitable carbon nanotube material containing entangled carbon nanotubes or combinations thereof.

In some embodiments, the carbon nanotube material can be produced by a Floating Catalyst Chemical Vapor Deposition (FC-CVD) method as described in U.S. Pat. No. 8,999,285, the contents of which are incorporated herein in their entirety. The FC-CVD method of carbon nanotube production can lead to very long nanotubes (>100 microns) that become well entangled while in the gas phase as they are being created. As the carbon nanotube material exits the hot zone of the furnace, the nanotubes entangle, bundle and otherwise coalesce into an extended network of interconnected and branching bundles that is not obtainable by other carbon nanotube production processes.

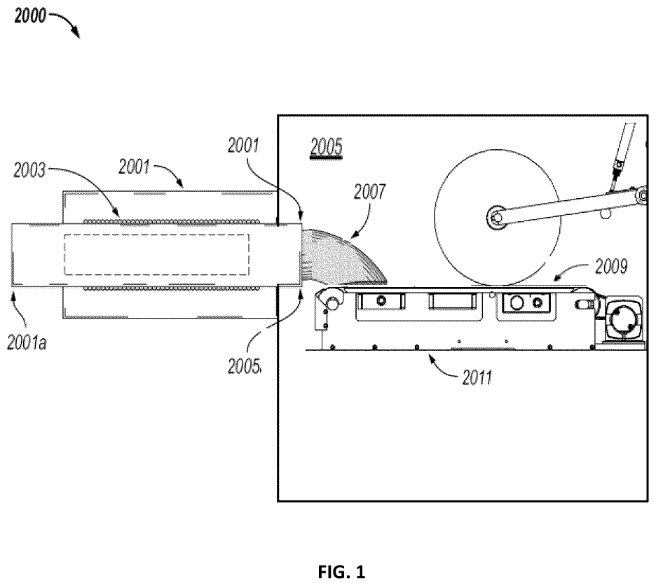

Referring now to FIG. 1, carbon nanotube material can be collected from the FV-CVD reactor by a collection system 2000. The system 2000, in some embodiments, can be coupled to a synthesis chamber 2001. The synthesis chamber 2001, in general, includes an entrance end 2001a, into which reaction gases may be supplied, a hot zone 2002, where synthesis of extended length nanotubes may occur, and an exit end 2001b from which the products of the reaction, namely the extended length nanotubes and exhaust gases, may exit and be collected. In some embodiments, synthesis chamber 2001 may include a tube 2003, extending through the hot zone 2002. Although illustrated generally in FIG. 1, it should be appreciated that other configurations may be employed in the design of synthesis chamber 2001.

The system 2000, in some embodiments, includes a housing 2005. The housing 2005, as illustrated in FIG. 1, may be substantially airtight to minimize the release of potentially hazardous airborne particulates from within the synthesis chamber 2001 into the environment, and to prevent oxygen from entering into the system 2000 and reaching the synthesis chamber 2001. In particular, the presence of oxygen within the synthesis chamber 2001 can affect the integrity and compromise the production of the nanotubes.

System 2000 may also include an inlet 2005a of the housing 2005 for engaging the exit end 2001b of the synthesis chamber 2001 in a substantially airtight manner. In some embodiments, as the carbon nanotubes exit the synthesis chamber 2001, the nanotubes entangle, bundle and otherwise coalesce into an extended network of interconnected and branching bundles. In some embodiments, these extended networks tend to form a hollow carbon nanotube “sock” similar in shape to a windsock inflated by a breeze. Thus, the carbon nanotubes can be collected within the housing 2005 from the synthesis chamber 2001 by drawing the carbon nanotube sock 2007 onto a rotating mesh substrate 2009 (e.g., by vacuum suction on a back side of the mesh substrate 2009) and removing the carbon nanotubes from the mesh substrate 2009 by a tool 2011, as shown in FIG. 1.

Although described above with reference to a collection system 2000 having a mesh substrate 2009 collection mechanism, it will be apparent in view of this disclosure that, in some embodiments, any technique for collecting and removing the carbon nanotubes from the FC-CVD environment without destroying their well entanglement can be used in accordance with various embodiments. For example, collection of the carbon nanotubes produced by FC-CVD, in some embodiments, can be performed by formation of carbon nanotube yarns or tows (e.g., by twisting collected carbon nanotubes together) and/or carbon nanotube sheets as described in U.S. Pat. Nos. 7,993,620 and 8,722,171, the contents of each of which are incorporated herein in their entirety.

In some embodiments, the carbon nanotubes can initially include iron or other inclusions. In other embodiments, such inclusions are unwanted and can be removed, preferably prior to use. For example, iron inclusions, in some embodiments, can be expunged from the carbon nanotubes by heating the nanotubes to a high temperature (e.g., about 1800° C.) in an inert or reducing atmosphere. At such temperatures the iron can be distilled out of the carbon nanotubes and re-solidified on a cooler surface. In some embodiments, such removal of inclusions can be performed, for example, in a CVD reactor such as an FV-CVD reactor described above, or any CVD reactor described, for example, in U.S. Pat. Nos. 8,999,285 and 7,993,620, the contents of each of which are incorporated herein in their entirety.

In some embodiments, inclusions such as, for example iron inclusions, can be removed by heating the carbon nanotube material to about 500° C. in air and then treating with an acid. In some embodiments, for example, the carbon nanotube material can be heated at 500° C. in air for about two hours and then treated with muriatic acid to remove iron inclusions.

In some embodiments, the carbon nanotubes are non-functionalized. In another embodiment, the carbon nanotubes within the nanotube material can be physically (for e.g., ultrasonicated or coated) or chemically modified (for e.g., with an acid, solvent, polymer or an oxidizer). Such modifications can involve the carbon nanotube ends, sidewalls, or both. Physical and chemical modifications may include, but are not limited to covalent bonding, ionic bonding, chemisorption, intercalation, surfactant interactions, polymer wrapping, cutting, solvation, and combinations thereof which results in the addition of functional groups to the carbon nanotubes, including, but not limited to, —COOH, —PO₄—, —SO₃—, —SO₃H, —SH, —NH₂, tertiary amines, quaternized amines, —CHO and/or —OH. In one embodiment, chemical modifications can include, for example, modifying with polysilazanes, polyureasilazane, conductive polymers, polyamine, polythiophene, infiltration with polyamides, chemical modification to introduce carboxylate or amine functionalities, any modification suitable for enhancing ionic conductivity or combinations thereof. In another particular embodiment, the functionalized carbon nanotube is one that includes an organic and/or inorganic compound attached to its surface with non-limiting examples of such organic compounds including at least one chemical group chosen from: carboxyl, amine, polyamide, polyamphiphiles, diazonium salts, pyrenyl, silane and combination thereof and non-limiting examples of the inorganic compounds including at least one fluorine compound of boron, titanium, niobium, tungsten, and combination thereof. The inorganic compounds as well as the organic compounds may also comprise a halogen atom or halogenated compound. In some embodiments, the carbon nanotubes are functionalized with from about 5%-100% of the sites available for functionalization or from about 10%-90% or from about 25%-75% or from about 50%-75% or from about 50%-100% of the sites available for functionalization.

According to one embodiment, the nanotube dispersion includes at least about 0.001% by weight, based on the total weight of the nanotube dispersion, of the carbon nanotube material. In still other embodiments, the nanotube dispersion includes at least about 0.005% by weight, or at least about 0.01% by weight, or at least about 0.1% by weight, or at least about 0.25% by weight, or at least about 0.5% by weight, or at least about 0.75% by weight, or at least about 1% by weight, based on the total weight of the nanotube dispersion, of the carbon nanotube material.

According to another embodiment, the nanotube dispersion includes less than about 20% by weight, based on the total weight of the nanotube dispersion, of the carbon nanotube material. In still other embodiments, the nanotube dispersion includes less than about 10% by weight, or less than about 7.5% by weight, or less than about 5% by weight or at less than about 2.5% by weight, based on the total weight of the nanotube dispersion, of the carbon nanotube material.

In still another embodiment, the nanotube dispersion includes about 0.001% by weight to about 20% by weight, based on the total weight of the nanotube dispersion, of the carbon nanotube material. In yet another embodiment, the nanotube dispersion includes about 0.01% by weight to about 7.5% by weight, or about 0.1% by weight to about 5% by weight or about 0.25% by weight to about 2.5% by weight, or about 0.5% by weight to about 1% by weight, based on the total weight of the nanotube dispersion, of the carbon nanotube material.

The nanotube dispersion may also include a dispersion additive. Examples of dispersion additives include, but are not limited to, polyvinylpyridines (e.g. poly(4-vinylpyridine) or poly(2-vinylpyridine)), polystyrene (PS), poly(4-vinylpyridine-co-styrene), poly(styrenesulfonate) (PSS), lignosulfonic acid, lignosulfonate, poly(phenylacetylene) (PPA), poly(meta-phenylenevinylene) (PmPV), polypyrrole (PPy), poly(p-phenylenebenzobisoxazole) (PBO), naturally occurring polymers, anionic aliphatic surfactants, poly(vinyl alcohol) (PVA), polyoxyethylene surfactants, poly(vinylidene fluoride) (PVDF), cellulose derivatives (generally and especially those in which the hydrogen atom in some hydroxyl groups in the glucose units has been replaced by methyl or ethyl or higher groups, for example methyl cellulose (MC) or ethyl cellulose (EC), cellulose derivatives in which the hydrogen atom in some hydroxyl groups in the glucose units has been replaced by hydroxymethyl, hydroxyethyl, hydroxypropyl or higher groups, for example hydroxymethyl cellulose (HMC), hydroxyethyl cellulose (HEC) or hydroxypropyl cellulose (HPC), cellulose derivatives in which the hydrogen atom in some hydroxyl groups in the glucose units has been replaced by carboxymethyl, carboxyethyl or higher groups, for example carboxymethyl cellulose (CMC) or carboxyethyl cellulose (CEC) or salts of CMC, including Sodium Carboxymethylcellulose (Na-CMC) and lithium CMC (Li-CMC), cellulose derivatives in which the hydrogen atom in some hydroxyl groups in the glucose units has been replaced partly by alkyl groups and partly by hydroxyalkyl groups, for example hydroxyethyl methyl cellulose (HEMC) or hydroxypropyl methyl cellulose (HPMC)), mixtures of different cellulose derivatives, polyacrylic acid (PAA), polyvinyl chloride (PVC), polysaccharides, styrene-butadiene rubber (SBR), polyamides, polyimides, block copolymers (for example acrylic block copolymers, ethylene oxide-propylene oxide copolymers) and mixtures thereof.

According to one embodiment, the nanotube dispersion includes at least about 0.001% by weight, based on the total weight of the nanotube dispersion, of one or more dispersion additives. In still other embodiments, the nanotube dispersion includes at least about 0.05% by weight, or at least about 0.1% by weight, or at least about 0.5% by weight, or at least about 1% by weight, or at least about 2% by weight, or at least about 3.5% by weight, or at least about 4% by weight, based on the total weight of the nanotube dispersion, of one or more dispersion additives.

In another embodiment, the nanotube dispersion includes less than about 20% by weight, based on the total weight of the nanotube dispersion, of one or more dispersion additives. In still other embodiments, the nanotube dispersion includes less than about 15% by weight, or less than about 10% by weight, or at less than about 8% by weight, or less than about 7% by weight, or less than about 6% by weight, or at less than about 5% by weight, or less than about 2.5% by weight, based on the total weight of the nanotube dispersion, of one or more dispersion additives.

In yet another embodiment, the nanotube dispersion includes from about 0.001% by weight to about 15% by weight, based on the total weight of the nanotube dispersion, of one or more dispersion additives. In still other embodiments, the nanotube dispersion includes from about 0.5% by weight to about 10% by weight, or from about 1% by weight to about 7% by weight, based on the total weight of the nanotube dispersion, of one or more dispersion additives.

The nanotube dispersion may also optionally include another conductive material. The other conductive material may be a conductive material other than carbon nanotube material, and examples include: conductive carbon materials such as graphite, carbon black (e.g., acetylene black, and furnace black), carbon nanohorns, vapor-grown carbon fiber, milled carbon fiber obtained by pyrolyzing and then pulverizing polymer fiber, single layer or multilayer graphene, and carbon non-woven fabric sheets obtained through pyrolysis of non-woven fabric made from polymer fiber; and fibers and foils of various metals and any combination thereof. In one embodiment, the mass ratio of the carbon nanotube material and the conductive material other than the carbon nanotube material is between 1:10 and 10:1 or between 1:3 and 3:1. In addition, the conductive material may also be added as a separate dispersion or as a powder in the preparation of the electrode slurry below.

In some embodiments, the total solids content concentration in the nanotube dispersion is 1 mass % or more, or 2 mass % or more, or even 3 mass % or more, and may be 20 mass % or less, or 15 mass % or less, or even 12 mass % or less.

The nanotube dispersion may be prepared by dispersing and mixing the components set forth above. The mixing method is not particularly limited, and may, for example, be carried out using a known mixer such as by a homogenizer, a Henschel mixer, a banbury mixer, a ribbon mixer, a V-shaped mixer, a planetary centrifugal mixer, a bead mill, a ball mill, a sand mill, a pigment disperser, a grinding machine, an ultrasonic disperser, a 3 roll mill, a roor-stator mixer, or a filmix mixer.

The presently disclosed nanotube dispersions exhibit enhanced dispersibility of carbon nanotube material within the nanotube dispersion and may be used in connection with various systems, such as secondary battery systems, waterborne epoxy systems, printing ink systems, or polymer systems.

Thus, in one embodiment, the nanotube dispersion in any of its various embodiments is useful for forming a nanotube film on a substrate to form an article having various desirable electrical, mechanical and/or thermal properties.

The nanotube film may be formed by applying the nanotube dispersion to a surface of the substrate using any suitable means, for example by painting, spraying, coating, and/or dipping to contact the substrate with the dispersion medium including the polyetheralkanol amine dispersant and the carbon nanotube material. At least a portion of the dispersion medium is then removed to form the nanotube film including the carbon nanotube material therein. Removal of the dispersion medium can be achieved by any suitable means, for example by actively drying/heating the dispersion medium on the substrate, or by simply allowing the dispersion medium to evaporate over an extended period. In some embodiments, all of the dispersion medium need not be removed to form the film, although in practice, all or a substantial fraction of the dispersion medium is removed to form the eventual nanotube film with its desired electrical and strength properties. In some embodiments, the nanotube film formation process can be repeated to assemble films with a larger thickness. For example, the substrate for a given application of the nanotube dispersion is a previously formed nanotube film of the same or different composition, with the result being the formation of a multilayered film.

The nanotube film can have any desired thickness, generally based on the selection of nanotube dispersion component concentrations and the number of film-forming steps performed to create the nanotube film. In particular, the nanotube film can have a thickness generally ranging from about 0.02 μm to about 500 μm, for example at least about 0.02 μm, at least about 0.2 μm, at least about 1 μm, at least about 2 μm, at least about 5 μm, at least about 10 μm, or at least about 20 μm and/or up to about 10 μm, up to about 20 μm, up to about 50 μm, up to about 100 μm, up to about 200 μm; up to about 300 μm, or up to about 500 μm.

The particular substrate to which the nanotube dispersion (and eventual nanotube film is formed on) is applied is not particularly limited, essentially including any desirable solid substrate. The substrate can be selected such that the nanotube film functionalizes or otherwise improves the properties of the substrate (i.e., the film containing the carbon nanotube material imparts its desirable properties (e.g., electrical, mechanical, thermal) to the substrate/composite). Examples of substrates include, but are not limited to, paper of all kinds (e.g., magician's paper, highly nitrated paper, mulberry paper, carbon fiber paper, fiberglass paper), metal weaves, fiberglass weaves, polymer surfaces in general, such as polyester, polycarbonate, polyamide, acrylic, polyurethane, polymethyl methacrylate, cellulose, triacetyl cellulose, amorphous polyolefin, polylactic acid, polyhydroxyalkanoate and polybutylene adipate co-terephthalate, polymer weaves, wood, silicon, glass, quartz, and metallic surfaces in general, such as stainless steel, aluminum, iron, gold, foil and silver.

The resulting articles may include, for example, epoxy and engineering plastic composites, filters, actuators, adhesive composites, elastomer composites, materials for thermal management (interface materials, spacecraft radiators, avionic enclosures and printed circuit board thermal planes, materials for heat transfer applications, such as coatings, for example), aircraft, ship infrastructure and automotive structures, improved dimensionally stable structures for spacecraft and sensors, materials for ballistic applications such as panels for air, sea, and land vehicle protection, body armor, protective vests, and helmet protection, tear and wear resistant materials for use in parachutes, for example, reusable launch vehicle cryogenic fuel tanks and unlined pressure vessels, fuel lines, packaging of electronic, optoelectronic or microelectromechanical components or subsystems, rapid prototyping materials, photovoltaic devices, an energy storage device such as a battery, capacitor, or super capacitor fuel cells, medical materials, composite fibers, improved flywheels for energy storage, sporting and consumer goods, O-rings, gaskets, or seals.

Hereinafter, for the purpose of illustration, a slurry for a secondary battery electrode that is produced using the presently disclosed nanotube dispersion, and an electrode for a secondary battery and a secondary battery that are produced using the slurry will be described.

The presently disclosed slurry for a secondary battery electrode contains an electrode active material and the nanotube dispersion set forth above. That is, the presently disclosed slurry for a secondary battery electrode contains at least an electrode active material, the carbon nanotube material, the polyetheralkanol amine dispersant set forth above, and a dispersion medium. In one embodiment, the dispersion medium includes water alone or a mixture of water and a solvent described above.

The electrode active material contained in the presently disclosed slurry for a secondary battery electrode is a material that accepts and donates electrons in an electrode of a secondary battery. For example, when the secondary battery is a lithium ion secondary battery, the electrode active material is normally a material that can occlude and release lithium.

In one embodiment, the electrode active material is a positive electrode active material. Examples of the positive electrode active material include, but are not limited to, known positive electrode active materials, such as lithium-containing cobalt oxides (LiCoO₂), lithium manganate (LiMn₂O₄), lithium-containing nickel oxides (LiNiO₂), lithium-containing composite oxides of Co—Ni—Mn (Li(CoMnNi)O₂), lithium-containing composite oxides of Ni—Mn—Al, lithium-containing composite oxides of Ni—Co—Al, olivine-type iron lithium phosphate (LiFePO₄), olivine-type manganese lithium phosphate (LiMnPO₄), Li₂MnO₃—LiNiO₂-based solid solution, lithium-rich spinel compound represented by Li₁₊ₓMn₂₋ₓO₄ (0<X<2), Li[Ni_{0.17}Li_{0.2}Co_{0.07}Mn_{0.56}]O₂, and LiNi_{0.5}Mn_{1.5}O₄.

According to another embodiment, the electrode active material is a negative electrode active material. Examples of the negative electrode active material include a carbon-based negative electrode active material, a metal-based negative electrode active material, and a negative electrode active material formed by combining these materials.

The carbon-based negative electrode active material may be defined as an active material that contains carbon as its main framework and into which lithium can be inserted (or “doped”). Examples of the carbon-based negative electrode active material include carbonaceous materials and graphitic materials.

Examples of carbonaceous materials include graphitizing carbon and non-graphitizing carbon, typified by glassy carbon, which has a structure similar to an amorphous structure. The graphitizing carbon may be a carbon material made using tar pitch obtained from petroleum or coal as a raw material. Specific examples of the graphitizing carbon include coke, mesocarbon microbeads (MCMB), mesophase pitch-based carbon fiber, and pyrolytic vapor-grown carbon fiber. Examples of the non-graphitizing carbon include sintered phenolic resin, polyacrylonitrile-based carbon fiber, quasi-isotropic carbon, sintered furfuryl alcohol resin (PFA), and hard carbon.

Examples of graphitic materials include natural graphite and artificial graphite. The artificial graphite may be an artificial graphite obtained by heat-treating carbon containing graphitizing carbon mainly at 2800° C. or higher, graphitized MCMB obtained by heat-treating MCMB at 2000° C. or higher, and graphitized mesophase pitch-based carbon fiber obtained by heat-treating mesophase pitch-based carbon fiber at 2000° C. or higher.

The metal-based negative electrode active material may be defined as an active material that contains metal, the structure of which usually contains an element that allows insertion of lithium, and that exhibits a theoretical electric capacity per unit mass of 500 mAh/g or more when lithium is inserted. For the metal-based negative electrode active material, for example, lithium metal, an elementary metal that can be used to form lithium alloys (for example, Ag, Al, Ba, Bi, Cu, Ga, Ge, In, Ni, P, Pb, Sb, Si, Sn, Sr, Zn, Ti, and the like) and alloys thereof; and oxides, sulfides, nitrides, silicides, carbides, and phosphides thereof can be used. Of these metal-based negative electrode active materials, active materials containing silicon (silicon-based negative electrode active materials) may be preferred. Examples of silicon-based negative electrode active materials include silicon (Si), silicon-containing alloys, SiO, SiOₓ, and composites of conductive carbon and Si-containing materials obtained by coating or combining the Si-containing materials with conductive carbon.

Other components that may be contained in the slurry for a secondary battery electrode include, but are not particularly limited to, a binder, a conductive material other than the carbon nanotube material, a reinforcing agent, a leveling agent, a wetting agent, a viscosity modifier, a crosslinking agent, an antioxidant, an electrolysis solution additive and any mixtures thereof.

In one embodiment, the total solids concentration of the slurry for a secondary battery electrode is not particularly limited as long as it is a viscosity capable of coating and immersing and having fluidity. Usually, it may be from about 10 mass % to about 80 mass %.

The slurry for a secondary battery electrode can be prepared by mixing the nanotube dispersion with the electrode active material and other optional components. The mixing method and mixer used are not specifically limited, and may, for example, be those used in the preparation of the nanotube dispersion. As to the mixing order, all of the components may be added collectively, or the components may be added in batches and then mixed together.

According to another embodiment, there is provided an electrode for a secondary battery which includes: a current collector; and a layer formed on the current collector, wherein the layer is formed from the slurry for a secondary battery electrode set forth above. That is, the electrode mixed material layer includes at least the electrode active material and the carbon nanotube material. Note that the components contained in the electrode mixed material layer are the same as those contained in the slurry for a secondary battery electrode set forth above. The preferred ratios of these components are the same as those previously described for the slurry for a secondary battery electrode.

The presently disclosed electrode for a secondary battery is produced, for example, through a step of applying the slurry for a secondary battery electrode disclosed herein onto the current collector (the “application step”), and a step of drying the slurry for a secondary battery electrode applied onto the current collector to form the layer on the current collector (the “drying step”).

The method by which the slurry for a secondary battery electrode set forth above is applied onto the current collector is not specifically limited and may be a commonly known method. Specific examples of application methods that can be used include doctor blading, dip coating, reverse roll coating, direct roll coating, gravure coating, extrusion coating, and brush coating. In the application step, the slurry for a secondary battery electrode may be applied onto just one side of the current collector or may be applied onto both sides of the current collector. The thickness of coating of the slurry for a secondary battery electrode on the current collector after the application and before drying may be set as appropriate in accordance with the thickness of the electrode mixed material layer to be obtained after drying.

The current collector onto which the slurry for a secondary battery electrode is applied is a material having electrical conductivity and electrochemical durability. Specifically, the current collector may be made of, for example, iron, copper, aluminum, nickel, stainless steel, titanium, tantalum, gold, platinum, or a carbon nanotube sheet. In one embodiment, the current collector is a carbon nanotube sheet comprising carbon nanotubes characterized as having one or more of the following characteristics: (i) a diameter of between about 1-100 nm, (ii) a length of between about 0.1-10 mm, (iii) a density of between about 0.3-1.9 g/cm³, (iv) an aspect ratio of at least about 100,000, (v) a strain to failure of between about 1.8-7%, and (vi) a surface area from about 100-300 m²/g. One of the aforementioned materials may be used individually, or two or more of the aforementioned materials may be used in combination in a freely selected ratio.

The slurry for a secondary battery electrode on the current collector may be dried by a commonly known method without any specific limitations. Examples of drying methods include: drying by warm, hot, or low-humidity air (e.g., in a convection oven); drying in a vacuum; and drying by irradiation with infrared light, electron beams, or the like. Drying of the slurry for a secondary battery electrode on the current collector in this manner forms the layer on the current collector and thereby provides an electrode for a secondary battery that includes the current collector and the layer.

After the drying step, the electrode may be further subjected to a pressing process, such as mold pressing or roll pressing. The pressing process can improve close adherence between the electrode mixed material layer and the current collector. In some embodiments, after the drying step, the electrode may be subjected to a temperature of at least 180° C. for a period of time to further improve its properties.

According to another embodiment, there is provided a secondary battery. The presently disclosed secondary battery includes a positive electrode, a negative electrode, an electrolyte solution, and a porous separator. In the presently disclosed secondary battery, the presently disclosed electrode for a secondary battery is used as at least one of the positive electrode and negative electrode. Since the presently disclosed secondary battery includes the presently disclosed electrode for a secondary battery, it has reduced battery resistance and improved life characteristics.

The presently disclosed secondary battery is preferably a secondary battery in which the presently disclosed electrode for a secondary battery is used as a positive electrode. Although the following describes, as one example, a case in which the secondary battery is a lithium ion secondary battery, the presently disclosed secondary battery is not limited to the following example, and may include a lithium-sulfur secondary battery, a sodium ion secondary battery, or a lithium air secondary battery.

Known electrodes that are used in production of secondary batteries can be used without any specific limitations in the presently disclosed secondary battery as an electrode other than the electrode for a secondary battery set forth above. Specifically, an electrode obtained by forming an electrode mixed material layer on a current collector by a known production method may be used as an electrode other than the electrode for a secondary battery set forth above.

The electrolyte solution is normally an organic electrolyte solution obtained by dissolving a supporting electrolyte in an organic solvent. The supporting electrolyte of a lithium ion secondary battery may, for example, be a lithium salt. Examples of lithium salts include LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)NLi. Of these, LiPF₆, LiClO₄, and CF₃SO₃Li are preferred, and LiPF₆ is particularly preferred, as they readily dissolve in solvents and exhibit a high degree of dissociation. One of these supporting electrolytes may be used individually, or two or more of these supporting electrolytes may be used in combination in a freely selected ratio. In general, lithium ion conductivity tends to increase when a supporting electrolyte having a high degree of dissociation is used. Therefore, lithium ion conductivity can be adjusted through the type of supporting electrolyte that is used.

The organic solvent that is used in the electrolyte solution is not particularly limited as long as the supporting electrolyte dissolves therein. Suitable examples include: carbonates such as dimethyl carbonate (DMC), ethylene carbonate (EC), diethyl carbonate (DEC), propylene carbonate (PC), butylene carbonate (BC), and ethyl methyl carbonate (EMC); esters such as γ-butyrolactone and methyl formate; ethers such as 1,2-dimethoxyethane and tetrahydrofuran; and sulfur-containing compounds such as sulfolane and dimethyl sulfoxide. A mixed solution of these organic solvents may also be used. Of these solvents, carbonates are preferred for their high dielectric constant and broad stable potential region, and a mixture of ethylene carbonate and ethyl methyl carbonate is more preferable.

The concentration of the supporting electrolyte in the electrolyte solution may be adjusted as appropriate and is, for example, preferably 0.5 mass % to 15 mass %, more preferably 2 mass % to 13 mass %, and even more preferably 5 mass % to 10 mass %. Known additives such as fluoroethylene carbonate and ethyl methyl sulfone may be added to the electrolyte solution.

The porous separator operates as both an electrical insulator and a mechanical support and is sandwiched between the negative electrode and the positive electrode to prevent physical contact between the two electrodes. In one embodiment, the porous separator is a polyolefin membrane. The polyolefin may be a homopolymer or a heteropolymer, and may be either linear or branched. If a heteropolymer derived from two monomer constituents is employed, the polyolefin may assume any copolymer chain arrangement, including those of a block copolymer or a random copolymer. The same holds true if the polyolefin is a heteropolymer derived from more than two monomer constituents. As examples, the polyolefin membrane may be formed of polyethylene (PE), polypropylene (PP), a blend of PE and PP, or multi-layered structured porous films of PE and/or PP.

In other examples, the porous separator may be formed from another polymer chosen from polyethylene terephthalate, polyvinylidene fluoride, polyamides (Nylons), polyurethanes, polycarbonates, polyesters, polyetheretherketones, polyethersulfones, polyimides, polyamide-imides, polyethers, polyoxymethylene (e.g., acetal), polybutylene terephthalate, polyethylenenaphthenate, polybutene, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes, polyarylene ether ketones, polyperfluorocyclobutanes, polytetrafluoroethylene, polyvinylidene fluoride copolymers and terpolymers, polyvinylidene chloride, polyvinylfluoride, liquid crystalline polymers, poly(p-hydroxybenzoic acid), polyaramides, polyphenylene oxide, and/or combinations thereof. In yet another example, the porous separator may be chosen from a combination of the polyolefin (such as PE and/or PP) and one or more of the polymers listed above.

The porous separator may contain a single layer or a multi-layer laminate fabricated from either a dry or wet process. For example, a single layer of the polyolefin and/or other listed polymer may constitute the entirety of the porous separator. As another example, however, multiple discrete layers of similar or dissimilar polyolefins and/or polymers may be assembled into the porous separator. In one example, a discrete layer of one or more of the polymers may be coated on a discrete layer of the polyolefin to form the porous separator. Further, the polyolefin (and/or other polymer) layer, and any other optional polymer layers, may further be included in the porous separator as a fibrous layer to help provide the porous separator with appropriate structural and porosity characteristics. Still other suitable porous separators include those that have a ceramic layer attached thereto, and those that have ceramic filler in the polymer matrix (i.e., an organic-inorganic composite matrix).

The presently disclosed secondary battery may be produced, for example, by stacking the positive electrode and the negative electrode with the separator in-between, rolling or folding the resultant stack as necessary in accordance with the battery shape to place the stack in a battery container, injecting the electrolyte solution into the battery container, and sealing the battery container. In order to prevent pressure increase inside the secondary battery and the occurrence of overcharging or over discharging, an overcurrent preventing device such as a fuse or a PTC device; an expanded metal; or a lead plate may be provided as necessary. The shape of the secondary battery may be a coin type, button type, sheet type, cylinder type, prismatic type, flat type, or the like.

### EXAMPLES

### Comparative Example 1: 0.75% CNT-PVDF Aqueous Cathode Dispersion

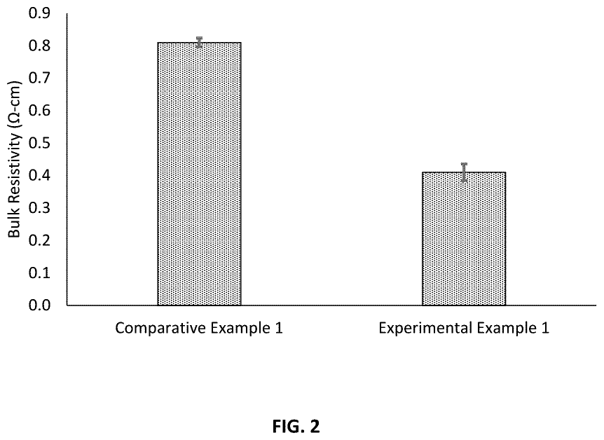

A 5% aqueous solution of CMC (Walocel® CRT 2000 from Dupont) was prepared by mixing with water for 5 cycles of 5 minutes for a total of 25 minutes at 3500 rpm using a FlackTek dual-axis orbital mixer to produce a clear CMC solution. The CMC solution was allowed to rest overnight and was re-mixed before use. 13.4 g of the CMC solution were combined with 15 g of a PVDF aqueous suspension (Kynar Latex 32 from Arkema), 0.5 g carbon nanotubes (CNT) available from Nanocomp Technologies, Inc. (Merrimack, NH) and 63.57 g of Active Cathode Material (NMC-532 from Targray) and was mixed for 5 minutes at 1900 rpm in the Flacktek mixer. Unless otherwise specified, the components were mixed in each step at ambient temperature (i.e., approximately 25° C.). The resulting dispersion was processed using a 3 Roll Mill (Torrey Hills Technology) for 15 passes with gaps of 70 microns and 35 microns. The resulting dispersion was diluted by 30% with water, mixed for 5 minutes at 1900 rpm in the Flackteck mixer, and a portion was cast onto a printed circuit (“PC”) board with tabs spaced to obtain a linear 4-point probe resistivity measurement. The cast film was dried in an open-air oven for one hour at 80° C. The cast film was calculated to be 0.75% CNT (by dry weight), 4% PVDF, 1% CMC with the rest Active Material. For this film the calculated bulk resistivity (average of 4 measurements) of the cast film was 0.810 ohm-cm with a standard deviation of 0.013 ohm-cm (see FIG. 2).

### Experimental Example 1: 0.75% CNT-CMC/PVDF Aqueous Cathode Dispersion with Polyetheralkanol Amine Dispersant

A 5% aqueous solution of CMC (Walocel® CRT 2000 from Dupont) was prepared and by mixing with water for 5 cycles of 5 minutes for a total of 25 minutes at 3500 rpm using a FlackTek dual-axis orbital mixer to obtain a clear CMC solution. The CMC solution was allowed to rest overnight and was re-mixed before use. 13.4 g of the CMC solution were combined with 15 g of a PVDF aqueous suspension (Kynar Latex 32 from Arkema), 0.5 g carbon nanotubes (CNT) available from Nanocomp Technologies, Inc. (Merrimack, NH), 3 g of 25% polyetheralkanol amine dispersant (JEFFSPERSE® X-3202 available from Huntsman Petrochemical LLC, The Woodlands, TX) in water and 63 g of Active Cathode Material (NMC-532 from Targray) and was mixed for 5 minutes at 1900 rpm in the Flacktek mixer. The resulting dispersion was processed using a 3 Roll Mill (Torrey Hills Technology) for 15 passes with gaps of 70 microns and 35 microns. The resulting dispersion was diluted by 15% with water, mixed for 5 minutes at 1900 rpm in the Flackteck mixer, and a portion was cast onto a PC board, dried, baked and tested as previously described. For this film the calculated bulk resistivity (average of 4 measurements) of the cast film was 0.410 ohm-cm with a standard deviation of 0.026 ohm-cm (see FIG. 2).

The bulk resistivities of the two examples described above are illustrated in FIG. 2. Experimental Example 1 has half the resistivity of Comparative Example 1 due to the presence of the polyetheralkanol amine dispersant. It was surprisingly found that the polyetheralkanol amine dispersant contributed to the smooth texture of the aqueous dispersion that cast well and had no large agglomerates of CNTs as well as contributed to a significantly lower resistivity.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. A nanotube dispersion comprising a dispersion medium, a polyetheralkanol amine dispersant comprising a compound having a structure of formula (1) and a compound having a structure of formula (2) 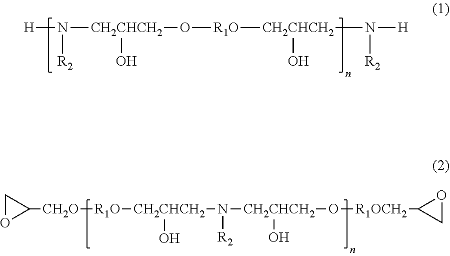
wherein each R₁ is a C₁-C₁₀₀ hydrocarbyl group; each R₂ is an alkoxylated hydrocarbyl group having a structure 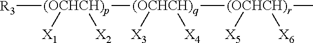
wherein R₃ is a C₁-C₂₄ hydrocarbyl group, X₁, X₂, X₃, X₄, X₅, and X₆ in each occurrence are independently selected from the group consisting of hydrogen, methyl and ethyl, subject to the proviso that at least one of the two X groups that are attached to the same alkoxy unit are hydrogen, p, q, and r may each independently be any integer from zero to about 100, subject to the proviso that at least one of p, q, and r is not zero; and each n is any integer from 1 to about 5, and a carbon nanotube material.

2. The nanotube dispersion of claim 1, wherein the carbon nanotube material comprises carbon nanotubes characterized as having one or more of the following characteristics: (i) a diameter of between about 1-100 nm, (ii) a length of between about 0.01-10 mm, (iii) a density of between about 0.3-1.9 g/cm³, (iv) an aspect ratio of at least about 10,000, (v) a strain to failure of between about 1.8-7%, and (vi) a surface area from about 100-300 m²/g.

3. The nanotube dispersion of claim 1, wherein the dispersion medium is an aqueous dispersion medium.

4. The nanotube dispersion of claim 3, wherein the aqueous dispersion medium comprises a substantial fraction of water.

5. The nanotube dispersion of claim 1, wherein the dispersion medium comprises at least one of 3-methyl-2-oxazolidinone, 2-methyloxolane, dihydrolevoglucosenone, and N,N′-dimethylethyleneurea.

6. The nanotube dispersion of claim 1, further comprising poly(vinylpyrrolidone), polyvinyl pyridine, polystyrene, poly(4-vinylpyridine-co-styrene), poly(styrenesulfonate), lignosulfonic acid, lignosulfonate, poly(phenylacetylene), poly(meta-phenylenevinylene), polypyrrole, poly(p-phenylenebenzobisoxazole), an anionic aliphatic surfactant, poly(vinyl) alcohol, a polyoxyethylene surfactant, poly(vinylidene fluoride), carboxymethyl cellulose or a mixture thereof.

7. The nanotube dispersion of claim 1, further comprising a conductive material selected from graphite, carbon black, carbon nanohorns, vapor-grown carbon fiber, milled carbon fiber obtained by pyrolyzing and then pulverizing polymer fiber, single layer graphene, multilayer graphene, a carbon non-woven fabric sheet obtained through pyrolysis of non-woven fabric made from polymer fiber and a mixture thereof.

8. The nanotube dispersion of claim 1, wherein the carbon nanotube material is dispersed in the dispersion medium.

9. An article comprising a substrate and a nanotube film formed on a surface of the substrate using the nanotube dispersion of claim 1.

10. The article of claim 9, wherein the nanotube film has a thickness ranging from about 0.02 m to about 500 m.

11. The article of claim 9, wherein the substrate comprises paper, a metal, foil, fiberglass, a polymer, wood, silicon, glass, or quartz.

12. The article of claim 11, wherein the substrate is paper or foil and the article is a current collector.

13. A slurry for a secondary battery electrode comprising an electrode active material and a nanotube dispersion comprising an aqueous dispersion medium, a polyetheralkanol amine dispersant and a carbon nanotube material.

14. The slurry of claim 13, wherein the electrode active material is a positive electrode active material.

15. The slurry of claim 14, wherein the positive electrode active material comprises a lithium-containing cobalt oxide, a lithium manganate, a lithium-containing nickel oxide, a lithium-containing composite oxides of Co—Ni—Mn, a lithium-containing composite oxide of Ni—Mn—Al, a lithium-containing composite oxide of Ni—Co—Al, an olivine-type iron lithium phosphate, an olivine-type manganese lithium phosphate, a Li₂MnO₃—LiNiO₂-based solid solution, a lithium-rich spinel compound represented by Li₁₊ₓMn₂₋ₓO₄ (0<X<2), Li[Ni_{0.17}Li_{0.2}Co_{0.07}Mn_{0.56}]O₂, or LiNi_{0.5}Mn_{1.5}O₄.

16. The slurry of claim 13, wherein the electrode is a negative electrode active material.

17. The slurry of claim 16, wherein negative electrode active material comprises a carbon-based negative electrode active material, a metal-based negative electrode active material or a mixture of the carbon-based negative electrode active material and the metal-based negative electrode active material.

18. The slurry of claim 17, wherein the metal-based negative electrode active material is a silicon-based negative electrode active material.

19. The slurry of claim 13, wherein the carbon nanotube material is dispersed in the dispersion medium

20. An electrode comprising a current collector and a layer formed on the current collector using the slurry of claim 12.

21. A secondary battery comprising the electrode of claim 20.

22. The secondary battery of claim 21, wherein the secondary battery is a lithium-ion battery, a lithium-sulfur battery, a sodium-ion battery, or a lithium air battery.
